(19) United States
(12) Patent Application Publication
(10) Pub. No.: US 2022/0391473 A1
(43) Pub. Date: Dec. 8, 2022

(54) Method for Determining an Inadmissible Deviation of the System Behavior of a Technical Device from a Standard Value Range

(71) Applicant: Robert Bosch GmbH, Stuttgart (DE)

(72) Inventor: Achim Romer, Weinsberg (DE)

(21) Appl. No.: 17/755,710

(22) PCT Filed: Nov. 5, 2020
(86) PCT No.: PCT/EP2020/081024

§ 371 Date: May 5, 2022

(30) Foreign Application Priority Data
Nov. 6, 2019 (DE) 10 2019 217 055.2

(51) Int. Cl. G06F 17/18; B60W 30/02

(52) U.S. Cl. CPC G06F 17/18; B60W 30/02

(57) ABSTRACT

A method determines an inadmissible deviation of a system behavior of a technical device using a monitoring algorithm which is supplied with input data and output data of the technical device in a learning phase. In a subsequent prediction phase, the monitoring algorithm is only supplied with the input data, and output data are calculated. In a preprocessing phase, the input data supplied to the monitoring algorithm are aligned with data of a reference signal.

The invention relates to a method for determining an inadmissible deviation of the system behavior of a technical device from a standard value range by means of a monitoring algorithm.

### PRIOR ART

DE 10 2018 206 805 B3 describes a method for predicting a driving maneuver of an object by means of two machine learning systems. The first machine learning system determines on the basis of a first input variable an output variable, which characterizes the object; the second machine learning system determines on the basis of a second input variable a second output variable, which characterizes a condition of the object. The future movement of the object is predicted on the basis of the output variables. The first machine learning system comprises a deep neural network, and the second machine learning system comprises a probabilistic graphical model.

DE 10 2018 209 916 A1 discloses a method for determining a series of output signals by means of a series of layers of a neural network on the basis of input signals that are supplied to an input layer of the neural network. At a defined time point, new input signals are already supplied to the neural network while the previous input signals are still propagating through the neural network.

### DISCLOSURE OF THE INVENTION

The method according to the invention can be used to determine an inadmissible deviation of the system behavior of a technical device from a standard value range. It is thereby possible to predict total or partial failure of the technical device even before the actual failure occurs, so that appropriate countermeasures can be taken in good time. It is thereby possible to monitor the condition of the technical device by measures that are simple to implement. Deteriorations in the system behavior and also system anomalies can be ascertained in good time. By virtue of defining and making a comparison with the standard value range, it is possible to monitor continuously the trend in the condition of the technical device, and to ascertain the time point until when it is guaranteed that the technical device will work correctly, and from when it is no longer possible, or not entirely possible, to ensure correct working.

The method for determining the inadmissible deviation of the technical device uses a monitoring algorithm, which, in a learning phase, is supplied with input data and output data of the technical device. By the comparison with the input data and output data of the technical device, the relevant connections in the monitoring algorithm are created, and the monitoring algorithm is trained on the system behavior of the technical device.

In a prediction phase, which follows the learning phase, the system behavior of the device can be predicted reliably in the monitoring algorithm. For this purpose, in the prediction phase, the monitoring algorithm is supplied only with the input data of the technical device, and, in the monitoring algorithm, output comparison data is computed that is compared with output data of the technical device. If this comparison yields that the difference in the output data of the technical device, which is preferably acquired as measured values, from the output comparison data of the monitoring algorithm deviates too widely and exceeds a limit value, then there exists an inadmissible deviation of the system behavior of the technical device from the standard value range. In response, suitable countermeasures can be taken, for example a warning signal can be produced or saved, or sub-functions of the technical device can be deactivated (degradation of the technical device). If applicable, alternative technical devices may be used in the event of an unacceptable deviation.

The above-described method can be used to monitor continuously a real technical device. In the learning phase, the monitoring algorithm is fed with enough information from the technical device both from its input side and from its output side to allow the technical device to be modeled and simulated in the monitoring algorithm with sufficient accuracy. This makes it possible in the subsequent prediction phase to monitor the technical device and to predict a deterioration in the system behavior. In particular the remaining useful life of the technical device can thereby be predicted.

In particular a neural network may be suitable as the monitoring algorithm. In the neural network, connections are created in the learning phase from the input and output data of the technical device, whereby the neural network models the system behavior of the technical device highly accurately. In the prediction phase, the neural network can accordingly be used for reliable prediction of a deterioration in the system behavior.

As an alternative to a neural network, monitoring algorithms mentioned elsewhere are also possible for monitoring the system behavior of the technical device.

In the method according to the invention, in a preprocessing step, which is performed before every learning-phase step and before every prediction-phase step, the input data supplied to the monitoring algorithm is normalized to the data of a reference signal. This procedure has the advantage that the normalization can correct, or at least largely correct, variations in the boundary conditions, for instance as a result of natural distribution, whereby, depending on the nature of the distribution, the processing in the learning phase and in the prediction phase is improved, in particular can be performed more quickly, or even made possible at all. The learning phase and the prediction phase of the monitoring algorithm remain intrinsically unaffected by the preprocessing step because only the input data is normalized in each phase.

According to an advantageous embodiment, the normalization relates to the number of items of input data supplied to the monitoring algorithm. If this number differs from the number of items of data of the reference signal, then normalization is performed so as to harmonize the number of items of input data with the number of items of data of the reference signal. The monitoring algorithm accordingly receives after the normalization always the same number of items of input data.

A further advantageous embodiment relates to the case in which although the number of items of input data equals the number of items of data of the reference signal, the input data is skewed with respect to the reference signal. Normalization can also be performed in this case by mapping the skewed input data onto the data of the reference signal. This procedure allows, for example, shifted maxima or minima in the input data to be mapped onto the data of the reference signal.

According to a further advantageous embodiment, the normalization of the input data supplied to the monitoring algorithm takes place in three sub-steps. The input data exists in time-discrete form, and in the first sub-step, time-normalization in a viewed time window onto the reference signal is performed. In a subsequent second sub-step, the non-normalized input data for the different time segments of the viewed time window is transformed into the frequency domain. This is followed by a third sub-step, in which the frequency segments associated with the different time segments are combined according to the time-normalization of the first sub-step. This results in normalized input data in the frequency domain, which is supplied as the input to the monitoring algorithm. The output comparison data, which is produced in the monitoring algorithm in the prediction phase, accordingly likewise exists in the frequency domain.

The comparison between the output comparison data of the monitoring algorithm and the output data of the technical device can be performed either in the time domain or in the frequency domain. For a comparison in the time domain, the output comparison data, which is present at the output of the monitoring algorithm, is transformed back from the frequency domain into the time domain, whereupon the comparison with the output data of the technical device can be performed in the time domain. For a comparison in the frequency domain, the output data of the technical device, which usually exists in the time domain, for instance as a measurement series, is transformed into the frequency domain. Thereafter, the output comparison data of the monitoring algorithm and the output data of the technical device can be compared with each other in the frequency domain.

According to a further advantageous embodiment, the time-normalization of the input data onto the reference signal, which is performed in the first sub-step, is carried out by means of dynamic time warping. This involves taking into consideration optimization aspects, in particular taking into account a cost functional, to set the optimized path through a matrix that provides the distance from each point of the reference signal to each point of the input data. Taking optimization aspects into consideration, the most cost-effective path through the matrix is that path for which the connection from the starting point to the end point forms the smallest sum.

According to a further advantageous embodiment, the transformation of the input data for the viewed time window into the frequency domain, which is performed in the second sub-step, is carried out by means of a short-time Fourier transform (STFT). In this transformation into the frequency domain, a fast Fourier transform (FFT) is performed for each of a multiplicity of time segments. This procedure has the advantage that the time information is retained even after the implementation into the frequency domain. Thus it is also possible to perform, if applicable, an inverse transformation into the time domain, in particular in order to perform a comparison with the output data of the technical device in the time domain.

The reference signal, on the basis of which the normalization is performed, is formed, for example, from a plurality of preceding items of input data, for instance by forming the average from a plurality of input signals.

Alternatively, it is also possible that the reference signal follows a defined maneuver that is matched to the technical device concerned and is typical of the technical device. For example in the automotive sector, it can be expedient to specify a defined driving maneuver of the vehicle, from which the reference signal is formed, related to the technical device used in the vehicle.

The invention also relates to an electronic device such as a control unit in a vehicle, which is equipped with means for performing the above-described method. These means are in particular at least one computing unit and at least one memory unit for performing the required computations or for storing input and output data.

In addition, the invention relates to a computer program product comprising program code that is designed to execute the above-described method steps. The computer program product can be stored on a machine-readable storage medium and can be run in an above-described electronic device.

The method can be applied by way of example to monitoring the condition of a technical system in a vehicle, for instance a steering system or a braking system. In this case, the electronic device is advantageously a control unit, by means of which the components of the technical device can be controlled. In addition, it is also possible within a larger system to monitor only a subsystem as the technical device, for instance an ESP module (electronic stability program) in a braking system.

Further advantages and expedient embodiments can be found in the further claims, the description of the figures, and the drawings, in which:

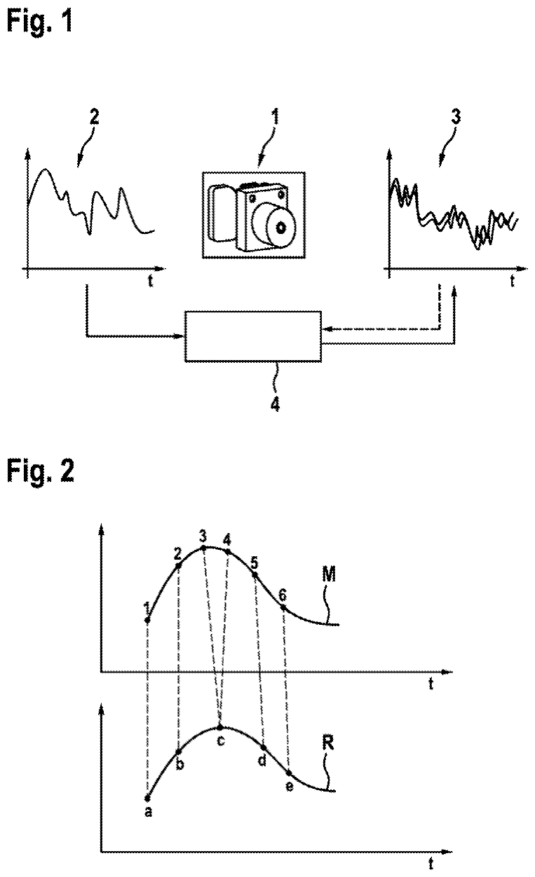

FIG. 1 is a block diagram containing a symbolic depiction of an ESP module which is supplied with input data, produces output data and is connected in parallel with a neural network;

FIG. 2 shows graphs of the variation over time of an input signal and a reference signal;

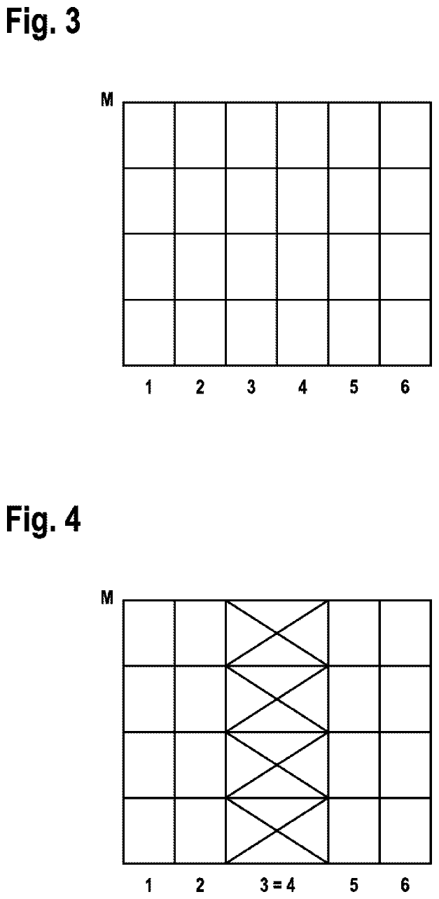

FIG. 3 is a diagram of the input signal transformed into the frequency domain in matrix form;

FIG. 4 shows the input signal transformed into the frequency domain including time-normalization according to FIG. 2.

The block diagram of FIG. 1 shows a schematic diagram of a technical device 1 in the form of an ESP module for a braking system in a vehicle having input data and output data and having a parallel-connected neural network 4. The ESP module 1 used by way of example as the technical device comprises an ESP pump for producing a desired modulated braking pressure in the braking system, and a control unit for controlling the ESP pump. Input data 2, for instance an input current for the electrically operable ESP pump of the ESP module 1, is supplied to the ESP module 1, which ESP module 1 produces output data 3, for instance a hydraulic braking pressure, in response to the input data 2.

Connected in parallel with the technical device 1 is a neural network 4, which forms a monitoring algorithm. The neural network 4 is trained in a learning phase to the system behavior of the technical device 1, for which purpose the neural network 4 is supplied in the learning phase with both the input data 2 and the output data 3 of the technical device 1. In FIG. 1, the dashed arrow from the output data 3 to the neural network 4 corresponds to the learning phase of the neural network, in which phase the neural network is also supplied with the output data 3 in addition to the input data 2.

After completion of the learning phase, the neural network 4 can be used in a prediction phase in order to ascertain in good time a deterioration in the system behavior of the technical device 1. For this purpose, in the prediction phase, the input data 2 of the technical device 1 is supplied as the input to the neural network 4, and the neural network 4 then produces output comparison data on the basis of its trained behavior (output from the neural network 4 represented by a continuous line). The output comparison data from the neural network 4 can be compared with the output data 3 of the technical device 1. If the difference between the output comparison data of the neural network 4 and the output data 3 of the technical device 1 lies outside a defined standard value range then there exists an inadmissibly large deterioration in the system behavior of the technical device 1, from which can be inferred a shortened service life or partial failure of the technical device 1. In response, measures can be taken such as, for instance, producing a warning signal or reducing the range of functions of the technical device 1.

The neural network 4 can be implemented and run in the control unit of the technical device 1. It is also possible, however, to have the neural network 4 running in a further control unit that is embodied separately from the control unit of the technical device 1.

FIGS. 2 to 4 show a preprocessing step, which is performed before each learning-phase step and before each prediction-phase step, and in which the input data supplied to the monitoring algorithm is normalized to the data of a reference signal.

FIG. 2 shows two graphs, one above the other, containing the time-dependent variation of a reference signal R (bottom graph) and of a signal containing measured input data M (top graph). The input data M corresponds to the input data 2 in FIG. 1. The reference signal R has a series of time points a, b, c, d and e. The signal containing the input data M comprises a series of time points 1 to 6 at which the values of the input data are measured. The reference signal R can be obtained, for example, from a multiplicity of preceding items of real input data of the technical device or of another technical device of identical design.

Although the signal curves R and M exhibit the same fundamental curve, they are not identical. In order to normalize the measured signal of the input data M, which contains the measured time points 1 to 6 numbering six in total, to the reference signal R, which contains a total of five time points a to e, dynamic time warping is performed in a first sub-step. This involves taking into consideration optimization aspects to find the most cost-effective path from the start to the end of the two signal curves R and M. This results in the association, represented by the dashed line, between the time points in the signal curves R and M having the association patterns 1a, 2b, 3c, 4c, 5d and 6e. The measured values in the signal curve M at the time points 3 and 4 are both associated with the time point c in the reference signal R.

FIG. 3 shows a schematic diagram of the input data M in the frequency domain. Here, in a second sub-step, the input data M is transformed into the frequency domain by means of a short-time Fourier transform STFT, which is achieved by performing a fast Fourier transform at each time point t=1 to t=6. This procedure has the advantage that the time information is retained even when transforming into the frequency domain. In the matrix shown in FIG. 3, each of the columns represents a vector transformed into the frequency domain and associated with one of the time points t=1 to 6.

FIG. 4 shows the third and last sub-step of the preprocessing of the input data, in which sub-step the matrix of the input data M from FIG. 3 is combined in accordance with the time-normalization in the first sub-step shown in FIG. 2. As a result, also in the frequency domain, as is shown in FIG. 4, the frequency segments that are associated with the time points 3 and 4 are combined to form a shared frequency segment. This results in a reduction in the frequency segments from six to five. The frequency segments 3 and 4 are combined, for example, by averaging the information in the respective vectors associated with the time points 3 and 4.

After completion of the preprocessing, the normalized input data M in the frequency domain can be supplied in the prediction phase to the monitoring algorithm implemented as the neural network, whereupon the neural network determines output comparison data in the frequency domain, which can be compared with associated output data of the technical device in the frequency domain. In the event of an inadmissible deviation indicating a deterioration in the system behavior of the technical device, an alarm signal can be produced, for example.

As an alternative to this procedure, it is also possible to transform from the frequency domain to the time domain the output comparison data computed in the neural network, and to compare this data with the output data of the technical device in the time domain. Again in this case, in the event of an inadmissibly high deviation indicating a deterioration in the system behavior, it is possible to produce an alarm signal or to take other measures, for instance degrading the functionality of the technical device or activating alternative technical devices.

1. A method for determining an inadmissible deviation of a system behavior of a technical device from a standard value range using a monitoring algorithm comprising:
in a learning phase, supplying the monitoring algorithm with input data and output data of the technical device;
in a prediction phase, which follows the learning phase, supplying the monitoring algorithm only with the input data of the technical device;
computing, in the monitoring algorithm, output comparison data;
ascertaining the inadmissible deviation of the technical device when, based on a difference from the output comparison data, the output data of the technical device lies outside the standard value range; and
in a preprocessing step, normalizing the input data supplied to the monitoring algorithm to data of a reference signal.

2. The method as claimed in claim 1, wherein in the preprocessing step, a number of items of the input data supplied to the monitoring algorithm is harmonized with a number of items of the data of the reference signal.

3. The method as claimed in claim 1 wherein in the preprocessing step, when a number of items of the input data and a number of items of the data of the reference signal are equal, but the input data is skewed with respect to the data of the reference signal, then the input data is mapped onto the data of the reference signal.

4. The method as claimed in claim 1, wherein:
in the preprocessing step, the normalization of the input data supplied to the monitoring algorithm, which input data is in time-discrete form, takes place in three sub-steps,
in a first sub-step, time-normalization of the input data in a viewed time window onto the reference signal is performed,
in a second sub-step, the input data for time segments of the time window is transformed into a frequency domain, and
in a third sub-step, frequency segments of the input data, which frequency segments are associated with different time segments, are combined according to the time-normalization of the first sub-step.

5. The method as claimed in claim 4, wherein the time-normalization of the input data onto the reference signal, which is performed in the first sub-step, is carried out using dynamic time warping.

6. The method as claimed in claim 4 wherein the transformation of the input data for the viewed time window into the frequency domain, which is performed in the second sub-step, is carried out using a short-time Fourier transform.

7. The method as claimed in claim 4, wherein the output data of the technical device is transformed into the frequency domain and compared in the frequency domain with the output comparison data computed in the monitoring algorithm.

8. The method as claimed in claim 4, wherein the output comparison data computed in the monitoring algorithm is transformed into a time domain and compared in the time domain with the output data of the technical device.

9. The method as claimed in claim 1, wherein the reference signal is formed from a plurality of preceding items of the input data.

10. The method as claimed in claim 1, wherein the reference signal corresponds to a defined driving maneuver of a vehicle.

11. The method as claimed in claim 1, wherein the monitoring algorithm is embodied as a neural network.

12. The method as claimed in claim 1, wherein a control unit in a vehicle is configured to perform the method.

13. The method as claimed in claim 1, wherein a computer program product includes program code configured to carry out the method.

14. The method as claimed in claim 13, wherein a non-transitory machine-readable storage medium is configured to store the computer program product.
